(19) United States
(12) Patent Application Publication
(10) Pub. No.: US 2023/0029010 A1
(43) Pub. Date: Jan. 26, 2023

(54) FUNCTIONAL FEED ADDITIVES AND ITS MANUFACTURING METHOD

(71) Applicant: WILLIAM KIM, MCKINNEY, TX (US)

(72) Inventor: WILLIAM KIM, MCKINNEY, TX (US)

(21) Appl. No.: 17/375,120

(22) Filed: Jul. 14, 2021

(51) Int. Cl. A23K 20/28; A23K 20/10; A23K 20/24; A23K 50/30

(52) U.S. Cl. CPC A23K 20/28; A23K 20/10; A23K 20/24; A23K 50/30

(57) ABSTRACT

A functional feed additive which may promote metabolism in livestock without the use of separate antibiotics, antibacterial agents and growth hormones, thereby increasing autoimmune cells to maximize the autoimmunity of livestock against various diseases, and which makes it possible to obtain meat containing increased amounts of unsaturated fatty acids beneficial to the human body and which has an effect of significantly reducing the complex odor of livestock excrement by removing ammonia gas (NH₃) generated from livestock excrement.

### BACKGROUND

### 1. Technical Field

The present disclosure relates to a functional feed additive and a production method therefor, and more particularly, to a functional feed additive capable of increasing the immunity and meat quality of livestock and having an effect of significantly reducing the complex odor of livestock excrement by removing ammonia gas (NH₃) generated from livestock excrement.

### 2. Related Art

The main problems of domestic and foreign livestock industries are that the proportion of the cost of disease burden is very high, and that economic efficiency and food hygiene quality and safety are greatly reduced due to the death and infection of livestock caused by these diseases. For example, it has been reported that the cost of disease burden in the domestic pig industry represents more than 25% of the total production cost of pigs.

The livestock industry is gradually becoming large-scale, and dense breeding in a limited space in consideration of economic efficiency is gradually increasing. For this reason, livestock are more easily exposed to diseases due to dense breeding.

For example, porcine respiratory diseases, which are diseases that represent a high proportion in the total production cost of pigs, show various lesions due to acute, subacute, chronic and inapparent infections and cause constant damage. In addition, porcine respiratory diseases are the most problematic for growing pigs and fed pigs in domestic pig farms and cause a lot of loss in terms of productivity and profitability.

The porcine respiratory diseases can cause further damage due to several factors such as unsanitary management, imbalance of nutritional status, and unsanitary conditions of breeding farms, such as improper temperature, humidity and air pollution of the breeding farms.

The porcine respiratory diseases are caused by various pathogens, including viruses, bacteria, parasites, and fungi, but in most cases, are caused by viruses and bacteria. Among bacterial porcine respiratory diseases, porcine pleural pneumonia which is caused by Actinobacillus pleuropneumoniae, a Gram-negative bacillus, is a disease that causes mass death and growth retardation of growing pigs and fed pigs.

Porcine pleural pneumonia has a variety of pathogenicity and serotypes due to the characteristics of pleuropneumoniae, and thus the effect of preventing porcine pleural pneumonia by vaccination is not satisfactory. In addition, in most pig farms, since a program of vaccination against porcine pleural pneumonia is done before the recommended time, the protective potency of the vaccine is not properly formed, and thus there is much damage even though the vaccination is done.

In addition, if the drug remains in the pork, it becomes a problem in terms of the food hygiene of consumers. For this reason, treatment with the drug against porcine pleural pneumonia cannot be performed in the late growth stage of pigs which are shipped as pork, and thus porcine pleural pneumonia is a disease difficult to control.

Meanwhile, known feed production methods is limited to methods of producing feed by microbial fermentation in which sterilized rice bran is inoculated with a predetermined amount of a cultured microbial preparation and fermented for a predetermined period under controlled conditions. These feed production methods do not satisfy sufficient conditions for an economical and effective functional feed. This is because the inoculated microorganism must be effectively cultured, a sterilization process for pure culture is required, and there is high dependence on ensuring sufficient amounts of the microorganism and a culture thereof.

In order to solve this problem, it has become important to ensure a natural effective microorganism based on unsterilized rice bran and to ensure fermentation conditions that do not require a sterilization process.

Accordingly, the present inventors have found that, when an additive is added to a feed instead of administering a drug in order to prevent diseases in livestock such as chickens, pigs and cattle, the additive may enhance immunity, improve meat quality, and improve metabolism so as to reduce the odor of livestock excrement and ammonia gas (NH₃), thereby increasing productivity.

To this end, the present inventors could develop a functional feed additive, which increases the immunity of livestock against diseases and improves meat quality, by producing a functional feed additive containing, as main components, an aluminosilicate compound, a carbonate compound, a zinc oxide compound and a magnesium oxide compound, which are mineral compounds and activate cells in vivo, a sodium compound and a potassium compound, which are necessary to maintain biological metabolic activity inside and outside cells.

Conventional methods are mostly based on the use of drugs and growth hormones, and when these drugs are excessively fed to livestock, disease-causing pathogens become increasingly resistant to the drugs, which may cause drug abuse. In addition, these drugs and growth hormones have problems associated with growth retardation and reduced meat quality, and for this reason, harmful substances such as the drugs and growth hormones are accumulated in the body of livestock, and the consumption of meat from the body in which the harmful substances are accumulated poses a big problem in terms of food safety.

### SUMMARY

An object of the present disclosure is to provide a functional feed additive which may promote metabolism in livestock without the use of separate antibiotics, antibacterial agents and growth hormones, thereby increasing autoimmune cells to maximize the autoimmunity of livestock against various diseases, and which makes it possible to obtain meat containing increased amounts of unsaturated fatty acids beneficial to the human body.

Another object of the present disclosure is to provide a functional feed additive that may greatly reduce the odor of livestock excrement by removing ammonia gas (NH₃) generated from livestock excrement.

Objects of the present disclosure are not limited to the above-mentioned problems, and other objects not mentioned herein will be clearly understood by those skilled in the art from the following description.

To achieve the above objects, a functional feed additive according to the present disclosure is produced by: preparing a mixture by uniformly mixing 1,000 g of rice bran, red ginseng residue, wheat bran, linseed, Perilla seed, rapeseed, soybean or hempseed, 5 to 15 g of calcium aluminosilicate, sodium aluminosilicate, or a mixture thereof, 15 to 50 g of sodium bicarbonate, sodium carbonate, potassium carbonate, or a mixture thereof, 0.4 to 1.2 g of zinc oxide, zinc sulfate, or a mixture thereof, and 1.0 to 4.5 g of magnesium oxide, magnesium sulfate, or a mixture thereof, in a mixing agitator; subjecting the prepared mixture to first fermentation at 30 to 40° C. for 4 days while maintaining the redox potential value of the mixing agitator at −10 to 50 mV and supplying water so that the water content of the mixture becomes 35 to 50 wt %; subjecting the mixture to second fermentation at 55 to 65° C. for 3 days while maintaining the redox potential value of the mixing agitator at −50 to 10 mV; and then drying the mixture.

The sodium aluminosilicate may be used in an amount of 5 to 15 g based on 1,000 g of the rice bran, the red ginseng residue, the wheat bran, the linseed, the Perilla seed, the rapeseed, the soybean or the hempseed.

The sodium bicarbonate, the sodium carbonate and the potassium carbonate may be used in amounts of 15 to 30 g, 20 to 40 g and 30 to 50 g, respectively, based on 1,000 g of the rice bran, the red ginseng residue, the wheat bran, the linseed, the Perilla seed, the rapeseed, the soybean or the hempseed.

The zinc oxide and the zinc sulfate may be used in amounts of 0.4 to 0.6 g and 0.8 to 1.2 g, respectively, based on 1,000 g of the rice bran, the red ginseng residue, the wheat bran, the linseed, the Perilla seed, the rapeseed, the soybean or the hempseed.

The magnesium oxide and the magnesium sulfate may be used in amounts of 1.0 to 1.5 g and 3.0 to 4.5 g, respectively, based on 1,000 g of the rice bran, the red ginseng residue, the wheat bran, the linseed, the Perilla seed, the rapeseed, the soybean or the hempseed.

A method for producing a functional feed additive according to the present disclosure includes: a step of preparing a mixture by uniformly mixing 1,000 g of rice bran, red ginseng residue, wheat bran, linseed, Perilla seed, rapeseed, soybean or hempseed, 5 to 15 g of calcium aluminosilicate, sodium aluminosilicate, or a mixture thereof, 15 to 50 g of sodium bicarbonate, sodium carbonate, potassium carbonate, or a mixture thereof, 0.4 to 1.2 g of zinc oxide, zinc sulfate, or a mixture thereof, and 1.0 to 4.5 g of magnesium oxide, magnesium sulfate, or a mixture thereof, in a mixing agitator; a first fermentation step of fermenting the prepared mixture at 30 to 40° C. for 4 days while maintaining the redox potential value of the mixing agitator at −10 to 50 mV and supplying water so that the water content of the mixture becomes 35 to 50 wt %; a second fermentation step of fermenting the mixture at 55 to 65° C. for 3 days while maintaining the redox potential value of the mixing agitator at −50 to 10 mV; and a step of drying the mixture.

The specific details of other embodiments are included in the detailed description.

### DETAILED DESCRIPTION

A functional feed additive according to one embodiment of the present disclosure is produced by mixing an aluminosilicate compound, a carbonate compound, a zinc oxide compound and a magnesium oxide compound, which have effects on living body cells, with rice bran, red ginseng residue, wheat bran, linseed, Perilla seed, rapeseed, soybean or hempseed, and fermenting the mixture. If necessary, the functional feed additive may be used in powder form by mixing the same with commercially available compound feed for easy consumption by livestock. When the functional feed additive is fed to livestock, it may maximize the activation of biologically active substances in the livestock.

The present inventors have conducted extensive studies, and as a result, have produced a functional feed additive through: a step of preparing a mixture by uniformly mixing rice bran, red ginseng residue, wheat bran, linseed, Perilla seed, rapeseed, soybean or hempseed with components, including an aluminosilicate compound (calcium aluminosilicate or sodium aluminosilicate), a carbonate compound (sodium bicarbonate, sodium carbonate or potassium carbonate), a zinc oxide compound (zinc oxide or zinc sulfate) and a magnesium oxide compound (magnesium oxide or magnesium sulfate), at a predetermined mixing ratio; a first fermentation step of fermenting the prepared mixture at 30 to 40° C. for 4 days while maintaining the redox potential value of the mixing agitator at −10 to 50 mV; a second fermentation step of fermenting the mixture at 55 to 65° C. for 3 days while maintaining the redox potential value of the mixing agitator at −50 to 10 mV; and a step of drying the mixture.

More specifically, the functional feed additive of the present disclosure is produced by: preparing a mixture by uniformly mixing 1,000 g of rice bran, red ginseng residue, wheat bran, linseed, Perilla seed, rapeseed, soybean or hempseed, 5 to 15 g of an aluminosilicate compound, 15 to 50 g of a carbonate compound, 0.4 to 1.2 g of a zinc oxide compound, and 1.0 to 4.5 g of a magnesium oxide compound, in a mixing agitator; subjecting the prepared mixture to first fermentation at 30 to 40° C. for 4 days while maintaining the redox potential value of the mixing agitator at −10 to 50 mV and supplying water so that the water content of the mixture becomes 35 to 50 wt %; subjecting the mixture to second fermentation at 55 to 65° C. for 3 days while maintaining the redox potential value of the mixing agitator at −50 to 10 mV; and then drying the mixture.

The rice bran, red ginseng residue, wheat bran, linseed, Perilla seed, rapeseed, soybean or hempseed that is used in the present disclosure may be a ground material obtained by grinding to a particle size of 40 mesh or less.

The aluminosilicate compound that is used in the present disclosure includes calcium aluminosilicate or sodium aluminosilicate. Even when these two components (calcium aluminosilicate and sodium aluminosilicate) are used together or any one selected from among the two components is used, there is no problem in achieving the object of the present disclosure. However, when the two components are used together, the two components are preferably added at a molar ratio of 1:1. Preferably, calcium aluminosilicate is preferably added in an amount of 5 to 15 g based on 1,000 g of the rice bran, red ginseng residue, wheat bran, linseed, Perilla seed, rapeseed, soybean or hempseed, and sodium aluminosilicate is preferably added in an amount of 5 to 15 g based on 1,000 g of the rice bran, red ginseng residue, wheat bran, linseed, Perilla seed, rapeseed, soybean or hempseed.

The carbonate compound that is used in the present disclosure includes sodium bicarbonate, sodium carbonate or potassium carbonate. One or more components selected from among these three components (sodium bicarbonate, sodium carbonate and potassium carbonate) may be used, but in this case, the selected components are preferably used at equal molar concentrations. Sodium bicarbonate, sodium carbonate and potassium carbonate are preferably used in amounts of 15 to 30 g, 20 to 40 g and 30 to 50 g, respectively, based on 1,000 g of the rice bran, red ginseng residue, wheat bran, linseed, Perilla seed, rapeseed, soybean or hempseed.

The zinc oxide compound that is used in the present disclosure includes zinc oxide or zinc sulfate. Even when these two components (zinc oxide and zinc sulfate) are used together or any one selected from among the two components is used, there is no problem in achieving the object of the present disclosure. However, when the two components are used together, the two components are preferably used at a molar ratio of 1:1. Zinc oxide and zinc sulfate are preferably used in amounts of 0.4 to 0.6 g and 0.8 to 1.2 g, respectively, based on 1,000 g of the rice bran, red ginseng residue, wheat bran, linseed, Perilla seed, rapeseed, soybean or hempseed.

The magnesium oxide compound that is used in the present disclosure includes magnesium oxide or magnesium sulfate. When these two components (magnesium oxide and magnesium sulfate) are used together, the two components are preferably added at a molar ratio of 1:1. For example, magnesium oxide and magnesium sulfate are preferably used in amounts of 1.0 to 1.5 g and 3.0 to 4.5 g, respectively, based on 1,000 g of the rice bran, red ginseng residue, wheat bran, linseed, Perilla seed, rapeseed, soybean or hempseed.

In the present disclosure, an experiment was conducted on piglets and shipment pigs in order to examine the protective effect against pleural pneumonia and the efficiency of feed. For pleural pneumonia, the following experimental methods were performed: an experimental method for challenging A. pleuropneumoniae serotype 5 intratracheally, and an experimental method for examining the onset of pleural pneumonia in shipment pigs raised in general pig farms. Actinobacillus pleuropneumoniae serotype 5 was used in the experiment after it was cultured with shaking in tryptic soy broth containing β-NAD at 37° C. for 48 hours.

The experimental method for challenge inoculation was generally performed by the following experimental methods on the basis of vaccinating 5-week-old and 7-week-old piglets against pleural pneumonia in domestic pig farms: an experimental method for challenging A. pleuropneumoniae serotype 5 intratracheally without vaccination, and an experimental method for challenging 5-week-old and 7-week-old piglets with A. pleuropneumoniae serotype 5 after vaccination.

In addition, the experiment in general pig farms was conducted on two general pig farms similar in terms of the number of mother pigs, breeding management, and the structure of the pig house, and experiments on pig respiratory diseases and feed efficiency were conducted for each pig farm fed with each of a control sample and a test sample during a period ranging from the time of growing pigs to shipment.

Hereinafter, the present disclosure will be described in more detail with reference to examples. These examples are presented to help understand the present disclosure, and the scope of the present disclosure is not limited thereto.

### Example 1 Production of Functional Feed Additive

A mixture was prepared by uniformly mixing 1,000 g of rice bran, 10 g of calcium aluminosilicate, 22.5 g of sodium bicarbonate, 40 g of potassium carbonate, 0.5 g of zinc oxide, and 3.75 g of magnesium sulfate in a mixing agitator. Then, water was supplied to the mixture so that the water content of the mixture became 40 to 45 wt %. Next, the agitation speed of the mixing agitator was adjusted, and the mixture was subjected to first fermentation at 30 to 40° C. for 4 days while the redox potential value of the mixing agitator was maintained at −10 to 50 mV. Next, the mixture was subjected to second fermentation at 55 to 65° C. for 3 days while the redox potential value of the mixing agitator was maintained at −50 to 10 mV. Then, the mixture was dried, thereby producing a functional feed additive.

### Test Example 1 Experiment on Changes in Effective Strains

Examination was made as to the formation of beneficial microorganisms during the production of the feed additive in Example 1 and changes in the levels of the microorganisms during distribution.

The results of the examination are shown in Table 1 below.

TABLE 1

| | Fermentation process | | | | | |
|---|---|---|---|---|---|---|
| | (days) | | | Distribution process | | |
| | 0 (before | | | (days) | | |
| Strains | addition) | 4 | 7 | 0 | 42 | 84 |
| Saccharomycetes | 4.2 × | 3.5 × | 8.6 × | 8.6 × | 7.4 × | 8.1 × |
| sp. | 10³ | 10⁷ | 10⁸ | 10⁸ | 10⁸ | 10⁴ |
| Bacillus sp. | 3.3 × | 2.3 × | 8.9 × | 8.9 × | 9.2 × | 9.2 × |
| | 10² | 10⁴ | 10⁴ | 10⁴ | 10⁴ | 10⁴ |

* note)
C.F.U = Colony-Forming Unit

(unit: C.F.U/g)

As shown in Table 1 above, it can be seen that the viable counts (CFU) of Saccharomycetes sp. and Bacillus sp. per g of the half-finished product increased after the first and second fermentation processes after the addition of the components listed in Example 1 to the rice bran compared to before the addition of these components, and that the effective strains were maintained at stable levels without decreasing during the distribution period.

This suggests that the functional feed additive of the present disclosure is effective in the growth and maintenance of effective live microorganisms.

### Test Example 2 Test (I) for Effect on Challenge with A. pleuropneumoniae and Efficiency of Feed (for Unvaccinated Piglets)

A total of fourteen 5-week-old healthy piglets, which were not infected with pleural pneumonia, were selected randomly from pig farms in consideration of the number of pregnancies of mother pigs, breed, sex and weight, and used in this experiment. The selected piglets were divided into a test group (n=7) fed with a starter feed containing 3% functional feed additive produced by fermentation in Example 1, and a control group (n=7) fed only with a general starter feed. The piglets of the test group and the control group were tested for 5 weeks from 5 weeks of age to 10 weeks of age. 7-week-old piglets were challenged intratracheally with 5×10⁶ CFU/ml of A. pleuropneumoniae serotype 5.

The breeding conditions within the pig house during the experimental period were maintained to be the same between the groups, and the piglets were allowed free access to drinking water.

The clinical symptoms and death of the piglets of each group were observed during the entire test period. Blood was periodically collected, and serum antibody titer against A. pleuropneumoniae serotype 5 was determined by an APP tube agglutination test. The serum was diluted 10-fold, and then diluted serially up to 1,280-fold, incubated at 37° C. for 2 hours, and then reacted at 4° C. for 18 hours. Then, positive control serum and antigen control, more than 10 folds were read as positive.

In addition, in order to measure the activity of blood immune cells to examine the resistance of each of the test group and the control group to A. pleuropneumoniae serotype 5 at each time point, white blood cells were extracted in accordance with the method of Davis (1987) and analyzed by fluorescence flow cytometry using a monoclonal antibody. Statistical processing was performed with a Student t-test for analysis of significance for each group.

In addition, after euthanasia, the body weight was measured, autopsy was performed, and lesions were visually observed. For observation of pulmonary lesions, the proportion of the weight of each lobe relative to the total lung weight was calculated according to the method of Straw (1986), in which the left and right apical lobes, the left and right cardiac lobes, and the intermediate lobe each contribute 10% of the total lung weight, and the left and right diaphragm lobes each contribute 25%. These scores were then used to calculate the total lung lesion score based on the relative contributions of each lobe.

Lung tissue showing pneumonia was confirmed by isolating and identifying the challenged A. pleuropneumoniae serotype 5 through microbiological examination. In addition, lesions were morphologically determined through pathological examination by fixing the lung lesion tissue with 10% neutral formalin, embedding the fixed tissue in paraffin, sectioning the embedded tissue to 4 μm, and staining the section with hematoxylin-eosin, followed by optical microscopic observation.

In addition, the average lung lesion was largely observed by gross findings and histopathological findings. As the characteristic gross findings of pleural pneumonia, bleeding, interlobular connective tissue thickening, fibrinous pleurisy, mucinous effusion, fibrinous pleurisy and abscess were observed and classified into mild (+), moderate (++) and severe (+++) symptoms.

As characteristic histopathological findings, typical fibrinous pleural pneumonia findings such as hematoma, dropsy, bleeding, thrombus, necrosis, inflammatory cell infiltration, fibrinous exudate, fibrinous and fibrous pleurisy, were observed and classified into mild (+), moderate (++) and severe (+++) symptoms.

In addition, early every morning for 3 weeks after challenge, clinical symptoms of respiratory diseases, such as loss of appetite, depression, fever, dyspnea, cough, rhinorrhea, etc. were observed and recorded. These symptoms were classified into very mild (±), mild (+), moderate (++), and severe (+++) symptoms, according to the degree of clinical symptoms observed for more than 7 days.

The results are shown in Table 2 below.

TABLE 2

| | | Control group | Test group |
|---|---|---|---|
| | | (n = 7) | (n = 7) |
| Average lung lesion (%) | | 22.3 | 18.4 |
| Daily gain (g/day) | | 449.7 | 462.5 |
| Feed conversion ratio | | 3.57 | 3.47 |
| Isolation rate (%) of | | 57.1 | 42.9 |
| pathogenic bacteria | | | |
| Clinical | Loss of | + | ±/+ |
| symptoms | appetite | | |
| | Depression | + | ±/+ |
| | Fever | + | + |
| | Dyspnea | +/++ | + |
| | Cough | ++/+++ | +/++ |
| | Rhinorrhea | +/++ | + |
| Immune | MHC-class | 15.34 ± 5.30 | 20.48 ± 2.39 |
| cells | II | | |
| | CD4 T | 23.7 ± 7.38 | 35.07 ± 5.67 |
| | B cell | 11.99 ± 3.27 | 15.71 ± 1.8 |

* note)
Feed efficiency = feed intake (kg)/kg body weight gain

There was no death during the test period, and as shown in the test results above, the daily gains of the test group and the control group after challenging 7-week-old piglets intratracheally with 5×10⁶ CFU/ml of A. pleuropneumoniae serotype 5 were 462.5 g/day and 449.7 g/day, respectively, and the feed conversion ratios thereof were 3.47 and 3.57, respectively. The test group showed a higher daily gain and a lower feed conversion ratio than the control group.

In the control group, mild to severe symptoms, such as dyspnea, cough and nasal rhinorrhea, which are typical clinical symptoms of respiratory diseases, were observed, whereas in the test group, mild to moderate symptoms were observed.

At the time of autopsy, the challenge inoculum was isolated and identified from the lungs. As a result, the test group showed a pathogenic bacteria isolation rate of 42.9% (3 of 7 heads), whereas the control group showed a high pathogenic bacteria isolation rate of 57.1% (4 of 7 heads).

The distribution rate of Major Histocompatibility Complex (MHC) Class II molecule-expressing cells involved in both cellular and humoral immunity of the host, most macrophages, CD4+ T lymphocytes, and B lymphocytes involved in antibody formation, significantly (p<0.1) increased in the test group compared to the control group.

In addition, as a result of pathological observation of lung lesions caused by A. pleuropneumoniae serotype 5 in the test group and the control group, the control group showed moderate to severe levels of fibrinous pleurisy, an acute symptom of pleural pneumonia, compared to the test group, and also showed a severe level of fibrous pleurisy, a chronic symptom of pleural pneumonia. Accordingly, it was shown that the average lung lesion was 18.4% in the test group, but was higher (22.3%) in the control group.

Vascular reactions, such as bleeding, dropsy, thrombus, and necrosis, which are typical histopathological symptoms of pleural pneumonia, infiltration of inflammatory cells mainly composed of neutrophils and macrophages, fibrinous exudate which indicates fibrin precipitation in the alveolar cavity, and acute inflammatory symptoms such as fibrinous pleurisy, were clearly observed in the control group compared to the test group. In addition, symptoms of fibrous pleurisy were easily observed in the control group compared to the test group, and abscess was also observed in the control group.

### Test Example 3 Test (II) for Effect on Challenge with A. pleuropneumoniae and Efficiency of Feed (Test for Vaccinated Piglets)

Fourteen 8-week-old piglets vaccinated against pleural pneumonia at 5 weeks of age and 7 weeks of age were selected randomly selected from a pig farm where pleural pneumonia was not a major problem in consideration of the number of pregnancies of mother pigs, breed, sex and weight, and were used in this experiment. The selected piglets were divided into a test group (n=7) fed with a starter feed containing 3% functional feed additive produced in Example 1, and a control group (n=7) fed only with a general starter feed.

The piglets of the test group and the control group were fed continuously for 5 weeks from 8 weeks of age to 13 weeks of age. At 11 weeks of age, the piglets were challenged intratracheally with 5×10⁸ CFU/ml of A. pleuropneumoniae serotype 5. Other test conditions and analysis conditions were identical to those described in Test Example 2.

The test results are shown in Table 3 below.

TABLE 3

| | | Control group | Test group |
|---|---|---|---|
| Average lung lesion (%) | | 15.2 | 11.4 |
| Daily gain (g/day) | | 570.0 | 589.7 |
| Feed conversion ratio | | 3.29 | 3.18 |
| Isolation rate (%) of | | 14.3 | 14.3 |
| pathogenic bacteria | | | |
| Clinical | Loss of | ±/+ | ± |
| symptoms | appetite | | |
| | Depression | ± | ± |
| | Fever | ±/+ | ±/+ |
| | Dyspnea | +/++ | + |
| | Cough | +/++ | + |
| | Rhinorrhea | + | + |
| Immune | MHC-class | 18.04 ± 4.65 | 19.09 ± 12.71 |
| cells | II | | |
| | CD4 T | 25.89 ± 6.29 | 24.66 ± 10.17 |
| | CD2 T | 71.62 ± 5.29 | 72.47 ± 1.84 |
| | B cell | 12.04 ± 6.61 | 14.61 ± 9.99 |
| | N | 24.70 ± 13.91 | 30.92 ± 10.62 |

There was no death during the test period, and as shown in the test results in Table 3 above, the daily gains of the test group and the control group after challenging 11-week-old piglets intratracheally with 5×10⁸ CFU/ml of A. pleuropneumoniae serotype 5 were 589.7 g/day and 570.0 g/day, respectively, and the feed conversion ratios thereof were 3.18 g/day and 3.29 g/day, respectively. That is, the test group showed a higher daily gain and a lower feed conversion ratio than the control group.

Early every morning for 2 weeks after intratracheal challenge, clinical symptoms of respiratory diseases, such as loss of appetite, depression, fever, dyspnea, cough, rhinorrhea, etc. were observed and recorded.

In the control group, mild to moderate symptoms, such as dyspnea, cough and nasal rhinorrhea, which are typical clinical symptoms of respiratory diseases, were observed, whereas in the test group, mild symptoms were observed.

At the time of autopsy, the challenge inoculum was isolated and identified from the lungs. As a result, the control group showed a low pathogenic bacteria isolation rate of 14.3% (1 of 7 heads), and the test group also showed a low pathogenic bacteria isolation rate (1 of 7 heads).

As a result of measuring the activity of blood immune cells in the test group and the control group, it was shown that the distribution rate of CD2+ T lymphocytes and N (Non T/Non B) lymphocytes, which are involved in primary immunity and are host defense cells against particularly viruses or tumors, significantly increased in the test group compared to the control group.

Lung lesions caused by A. pleuropneumoniae serotype 5 in the test group and the control group were observed by gross findings and histopathological findings. As a result, it was observed that the test group showed mild symptoms, whereas the control group showed thickening of interlobular connective tissue, which is an acute symptom of fibrinous pleurisy, and mild to moderate symptoms of fibrinous pleurisy, which are somewhat severe. In other gross findings, there were no differences in lesions. It was shown that the average lung lesion was 11.4% in the test group, but was higher (15.2%) in the control group.

Vascular reactions, such as bleeding, dropsy, thrombus, and necrosis, which are typical histopathological symptoms of pleural pneumonia, infiltration of inflammatory cells mainly composed of neutrophils and macrophages, fibrinous exudate which indicates fibrin precipitation in the alveolar cavity and the appearance of fibrous cells, and fibrinous and fibrous pleurisy, were clearly observed in the control group compared to the test group.

### Test Example 4 Test for Pneumonia Occurrence Characteristics and Feed Efficiency for Pigs Shipped from General Pig Farms

On two general pig farms similar in terms of the number of mother pigs, breeding management, and the structure of the pig house, an experiment on pig respiratory diseases was conducted during a period ranging from the time of growing pigs to shipment. The pigs used in the experiment were roughly divided into a test group (n=118) fed with a general feed containing the feed additive produced in Example 1, and a control group (n=120) fed only with a general feed.

For pigs shipped, a carcass test for lungs was at the slaughterhouse. As the test method, the PigMON program developed by the University of Minnesota (USA) was used. Based on the method of Pointon et al. (1992), the lung lesions by Straw et al. (1986) were evaluated by lung lesion score (0 to 5 points): 1=1 to 10%, 2=11 to 20%, 3=21 to 30%, 4=31 to 40%, and 5=41% or more. Here, 1=mild lesion, 2 and 3=moderate lesion, and 4 and 5=severe lesion. In order to confirm lung lesions, defecation and abdominal stool were necessarily examined and facilitated.

For classification of pneumonia lesions, epidemic pneumonia (enzootic pneumonia or Mycoplasma pneumonia) was examined by the degree of the lesion, and locally raised hemorrhagic necrotizing fibrinous lesions or purulent pleurisy lesions that are characteristic lesions of pleural pneumonia. For pleuritis, observation was made as to whether there were adhesions between the lung lobes and whether there were adhesions between the lung lobes and the chest wall, pericardium and mediastinum, and observation was also made as to whether these adhesions were normal lungs or lungs showing pneumonic lesions. For the test group and the control group, feed efficiency, shipment age (days) and growth rate such as body weight at shipment were recorded and comparatively analyzed. Other test conditions and analysis methods were identical to those described in Test Example 2.

The results are shown in Table 4 below.

TABLE 4

| | Control group | Test group |
|---|---|---|
| Average lung | 12.8 | 8.80 |
| lesion (%) | | |
| Average lung | 1.65 | 1.29 |
| lesion score | | |
| Number of pigs | 102 | 93 |
| showing pneumonia | | |
| Number of pigs | 18 | 7 |
| showing pleural | | |
| pneumonia | | |
| Shipment age | 170 | 163 |
| (days) | | |
| Average body | 108.3 | 114.1 |
| weight (kg) at | | |
| shipment | | |
| Feed conversion | 2.87 | 2.21 |
| ratio | | |

As shown in Table 4 above, the number of pigs showing pneumonia among the 118 shipped pigs of the test group was 93 (78.8%), and the test group showed an average lung lesion of 8.80% and an average lung lesion score of 1.29. The number of pigs showing pneumonia among the 120 shipped pigs of the control group was 102 (85.0%), and the control group showed an average lung lesion of 12.8% and an average lung lesion score of 1.65.

When looking at the classification of lung lesions observed in pigs shipped, the test group showed a pleural pneumonia incidence rate of 5.9% (7 pigs), and the control group showed a pleural pneumonia incidence rate of 15.0% (18 pigs).

In addition, the test group showed an average weight at shipment of 114.1 kg at 163 days of age and a feed conversion ratio of 2.21, whereas the control group showed an average weight at shipment of 108.3 kg at 170 days of age and a feed conversion ratio of 2.87.

From the test results in Test Examples 2, 3 and 4, it was confirmed that the method for producing a functional feed additive according to the present disclosure significantly increases lymphocyte immune cells, including MHC-class II cells, which play a pivotal role in the biological immune mechanism. In addition, in the pigs exposed to the disease, the feed intake rate was generally low, causing a decrease in feed efficiency, resulting in a longer shipping age and a decrease in average weight at shipment, whereas in pigs fed with the feed additive of the present disclosure, the shipment age was relatively shortened, the average weight at shipment was high, and the odor of livestock excrement was greatly reduced by removing ammonia gas (NH₃) generated from livestock excrement.

As described above, the functional feed additive according to the present disclosure and the functional feed additive produced according to the method for producing the same have the effect of enhancing autoimmune function in livestock by activating biological function in livestock.

In addition, the functional feed additive according to the present disclosure and the functional feed additive produced according to the method for producing the same have the effect of increasing unsaturated fatty acids in livestock meat quality by promoting digestion efficiency.

In addition, the functional feed additive according to the present disclosure and the functional feed additive produced according to the method for producing the same have the effect of producing fermented feed without separate inoculation of fermented strains or excessive facilities by killing harmful bacteria and proliferating effective fermenting bacteria.

In addition, the functional feed additive according to the present disclosure and the functional feed additive produced according to the method for producing the same have the effect of significantly reducing the complex odor of livestock excrement by removing ammonia gas (NH₃) generated from livestock excrement. In fact, through the test conducted by the Gyeonggi-do Institute of Health & Environment Research (Korea), it could be confirmed that the concentration of ammonia gas (NH₃) in rural livestock houses was greatly reduced from 300 ppm to 10 ppm.

The effects of the present disclosure are not limited to the above-mentioned effects, and other effects not mentioned herein will be clearly understood by those skilled in the art from the description of the claims.

Those of ordinary skill in the art to which the present disclosure pertains will understand that the present disclosure may be embodied in other specific forms without changing the technical spirit or essential features thereof. Therefore, it should be understood that the embodiments described above are illustrative in all respects and not restrictive. The scope of the present disclosure is defined by the following claims rather than the detailed description, and it should be construed that all changes or modifications derived from the meaning and scope of the claims and equivalents thereto are included within the scope of the present disclosure.

What is claimed is:

1. A functional feed additive produced by:
preparing a mixture by uniformly mixing 1,000 g of rice bran, red ginseng residue, wheat bran, linseed, Perilla seed, rapeseed, soybean or hempseed, 5 to 15 g of calcium aluminosilicate, sodium aluminosilicate, or a mixture thereof, 15 to 50 g of sodium bicarbonate, sodium carbonate, potassium carbonate, or a mixture thereof, 0.4 to 1.2 g of zinc oxide, zinc sulfate, or a mixture thereof, and 1.0 to 4.5 g of magnesium oxide, magnesium sulfate, or a mixture thereof, in a mixing agitator;
subjecting the prepared mixture to first fermentation at 30 to 40° C. for 4 days while maintaining a redox potential value of the mixing agitator at −10 to 50 mV and supplying water so that a water content of the mixture becomes 35 to 50 wt %; subjecting the mixture to second fermentation at 55 to 65° C. for 3 days while maintaining the redox potential value of the mixing agitator at −50 to 10 mV; and then drying the mixture.

2. The functional feed additive of claim 1, wherein the sodium aluminosilicate is used in an amount of 5 to 15 g based on 1,000 g of the rice bran, the red ginseng residue, the wheat bran, the linseed, the Perilla seed, the rapeseed, the soybean or the hempseed.

3. The functional feed additive of claim 1, wherein the sodium bicarbonate, the sodium carbonate and the potassium carbonate are used in amounts of 15 to 30 g, 20 to 40 g and 30 to 50 g, respectively, based on 1,000 g of the rice bran, the red ginseng residue, the wheat bran, the linseed, the Perilla seed, the rapeseed, the soybean or the hempseed.

4. The functional feed additive of claim 1, wherein the zinc oxide and the zinc sulfate are used in amounts of 0.4 to 0.6 g and 0.8 to 1.2 g, respectively, based on 1,000 g of the rice bran, the red ginseng residue, the wheat bran, the linseed, the Perilla seed, the rapeseed, the soybean or the hempseed.

5. The functional feed additive of claim 1, wherein the magnesium oxide and the magnesium sulfate are used in amounts of 1.0 to 1.5 g and 3.0 to 4.5 g, respectively, based on 1,000 g of the rice bran, the red ginseng residue, the wheat bran, the linseed, the Perilla seed, the rapeseed, the soybean or the hempseed.

6. A method for producing a functional feed additive, the method comprising:
a step of preparing a mixture by uniformly mixing 1,000 g of rice bran, red ginseng residue, wheat bran, linseed, Perilla seed, rapeseed, soybean or hempseed, 5 to 15 g of calcium aluminosilicate, sodium aluminosilicate, or a mixture thereof, 15 to 50 g of sodium bicarbonate, sodium carbonate, potassium carbonate, or a mixture thereof, 0.4 to 1.2 g of zinc oxide, zinc sulfate, or a mixture thereof, and 1.0 to 4.5 g of magnesium oxide, magnesium sulfate, or a mixture thereof, in a mixing agitator;
a first fermentation step of fermenting the prepared mixture at 30 to 40° C. for 4 days while maintaining the redox potential value of the mixing agitator at −10 to 50 mV and supplying water so that a water content of the mixture becomes 35 to 50 wt %;
a second fermentation step of fermenting the mixture at 55 to 65° C. for 3 days while maintaining the redox potential value of the mixing agitator at −50 to 10 mV; and
a step of drying the mixture.
